(19) United States
(12) Patent Application Publication
(10) Pub. No.: US 2015/0317709 A1
(43) Pub. Date: Nov. 5, 2015

(54) SYSTEM AND METHOD THEREOF FOR EFFECTUATING AN ELECTRONIC NEGOTIATION BETWEEN A CONSUMER DEVICE AND A MERCHANT

(71) Applicant: Personali Inc., Waltham, MA (US)

(72) Inventors: Keren Zimmerman, Tel Aviv (IL); Noam JAVITS, Tel Aviv (IL)

(73) Assignee: Personali Inc., Waltham, MA (US)

(21) Appl. No.: 14/795,050

(22) Filed: Jul. 9, 2015

Related U.S. Application Data
(63) Continuation of application No. PCT/US14/55578, filed on Sep. 15, 2014.
(60) Provisional application No. 61/877,984, filed on Sep. 15, 2013.
(60) Provisional application No. 61/908,758, filed on Nov. 26, 2013.

(51) Int. Cl. G06Q 30/06

(52) U.S. Cl. CPC G06Q 30/0611

(57) ABSTRACT

A method and system are provided for effectuating an electronic negotiation between a consumer device and a merchant. The method includes identifying an interest of the user respective of a product offered by the merchant on an e-commerce website based on a received indication from the e-commerce web site; requesting a counter offer to a price requested by the e-commerce website; upon receiving the counter offer, retrieving metadata associated with the product; computing a score representing a probability that a merchant of the product would accept the counter offer based on the retrieved metadata; selecting at least one content item for display on the consumer device in response to the counter offer, the at least one content item is selected based on the counter offer and the retrieved metadata; and causing a display of the at least one selected content item on a display of the consumer device.

### CROSS REFERENCE TO RELATED APPLICATIONS

This application is a continuation of International Application No. PCT/US2014/055578 filed Sep. 15, 2014 which claims the benefit of U.S. Provisional Patent Application No. 61/877,984 filed Sep. 15, 2013 and U.S. Provisional Patent Application No. 61/908,758 filed on Nov. 26, 2013, the contents of which are hereby incorporated by reference.

### TECHNICAL FIELD

The invention generally relates to a computerized negotiation platform for electronic commerce (E-commerce) websites, and more specifically to platforms for motivating consumers to negotiate with merchants over the web.

### BACKGROUND

The way people shop has progressed significantly since the development of the worldwide web (WWW). Consumers can now shop from the convenience of their home, office, or while on the road using portable devices. Popular websites such as Amazon.com® and Shopping.com®, though different by nature, allow consumers to purchase goods directly through the website, sometimes at much lower prices than the prices suggested by local merchants. From a merchant's perspective, such websites allow access to a worldwide market of consumers.

The services provided by websites such as Shopping.com® belong to a category of websites that provide comparison shopping engines (CSE) that assist consumers by presenting prices and information about a product the consumer may be interested in purchasing. In response to a consumer's query, the consumer is provided with a list of possibilities based on characteristics such as price and popularity. The CSE is generally considered to be an effective tool for consumers.

As another example, Priceline.com® allows a consumer to make a bid for a traveling service, such as a hotel room reservation. In response, the service provider (e.g., either Priceline.com or the hotel), can either accept or reject that bid. In response, the consumer can either search for another alternative or raise the bid until it is accepted by the service provider. The disadvantage of such an approach is that the consumer does not know the particulars of the vendor or service provider. For example, the consumer selects the area and rating of a hotel he or she desires to stay at, but the consumer cannot bid on a specific hotel. Further, all bids placed by the consumer are binding and no true negotiation take place.

Other disadvantages associated with electronic commerce (e-commerce) websites relate to the lack of personal interaction between the consumer and the merchant. At best, the personal interaction is limited to a chat with a sale representative who can provide more information about the goods/services that can be purchased through the e-commerce web-site. Another way to motivate consumers to purchase through e-commerce websites is to offer generic discounts to all the consumers visiting the website.

In the existing art, there is no solution that allows customized personal interaction with the consumers to motivate them to purchase on-line. Thus, it would be advantageous to provide a solution that overcomes the disadvantages of e-commerce web-sites.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all embodiments. Its sole purpose is to present some concepts of one or more embodiments in a simplified form as a prelude to the more detailed description that is presented later. For convenience, the term some embodiments may be used herein to refer to a single aspect or multiple embodiments of the disclosure.

The disclosure further relates in various embodiments to a method for effectuating an electronic negotiation between a consumer device and a merchant. The method comprises receiving an indication that a user of the consumer device browses products for sale on an e-commerce website; identifying an interest of the user respective of a product offered on by the merchant the e-commerce website; requesting a counter offer to a price requested by the e-commerce website; upon receiving the counter offer, retrieving metadata associated with the product; computing a score representing a probability that a merchant of the product would accept the counter offer based on the retrieved metadata; selecting at least one content item for display on the consumer device in response to the counter offer, wherein the at least one content item is selected based on the counter offer and the retrieved metadata, wherein the at least one selected content item is designed to incentivize the user to improve the counter offer; and causing a display of the at least one selected content item on a display of the consumer device.

### BRIEF DESCRIPTION OF THE DRAWINGS

The subject matter disclosed herein is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram of a network system utilized to described the various disclosed embodiments;

FIG. 2 is a flowchart describing a method for effectuating an electronic negotiation between a consumer device and a merchant accordance with one embodiment; and

FIG. 3 is a screenshot showing a widget displayed to a user responsive to an offer to purchase a product.

### DETAILED DESCRIPTION

The embodiments disclosed by the invention are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

As an example of the above, some of the embodiments disclosed herein configure a system to track the activity of a user (a potential consumer) when browsing an e-commerce web site. Upon determination that the user may have an interest in receiving an offer to purchase a certain good or service (hereinafter collectivity referred to as a “product”), the system allows the user to counter the offer. The system is configured to collect metadata related to the merchant and to the product. Using the gathered metadata, the real-time estimation of whether the merchant will accept the counter offer is generated. In an embodiment, an alternative offer respective of the counter offer and the collected metadata is generated and proposed to the user to motivate or incentivize the user to make a sale.

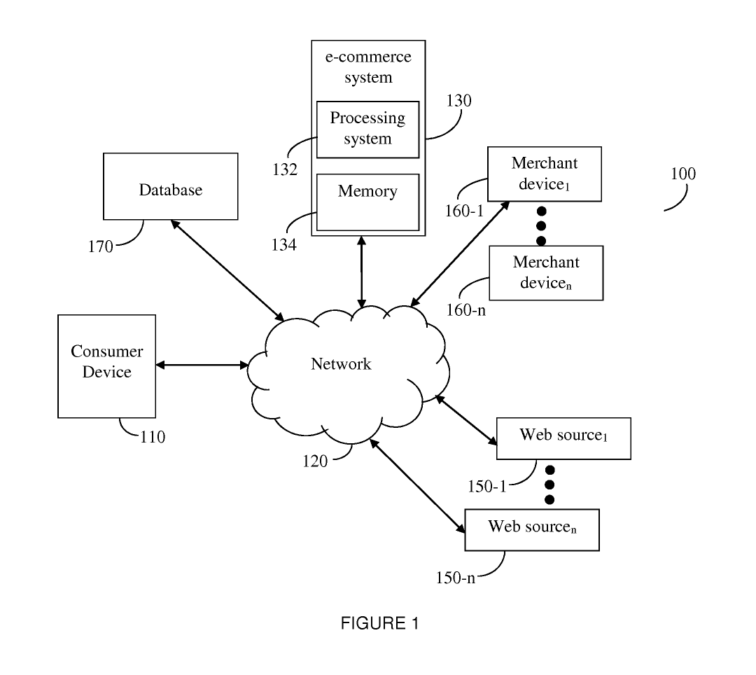

FIG. 1 depicts an exemplary and non-limiting schematic diagram of a system 100 in accordance with an embodiment. A user, by means of a consumer device 110, is connected to a network 120. The consumer device 110 may be, but is not limited to, a personal computer (PC), a laptop computer, a smart phone, a wearable computing device, a tablet computer, and so on.

The consumer device 110 is configured to allow access to web sites for at least the purpose of performing e-commerce transactions. The network 120 can be wired or wireless, a local area network (LAN), a wide area network (WAN), a metro area network (MAN), the Internet, the worldwide web (WWW), the like, and any combinations thereof.

An e-commerce system 130 is further connected to the network 120. The e-commerce system 130 typically comprises a processing system 132 connected to a memory 134. The memory 134 contains a plurality of instructions that are executed by the processing system 132. Specifically, the memory 132 may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The processing system 132 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The consumer device 110 can communicate with one or more web sources 150-1 through 150-n (hereinafter referred to collectively as web sources 150 or individually as a web source 150, merely for simplicity purposes), ‘n’ having integer values beginning with ‘1’, through the e-commerce system 130. The web sources 150 may be electronic commerce (e-commerce) websites, travel websites, services websites, and any other web source through which the user is able to purchase goods or services.

The web sources 150-1 through 150-n are operated by merchant devices 160-1 through 160-m, ‘m’ having integer values beginning with ‘1.’ One merchant device 160, for example merchant device 160-1, may operate one or more web sources 150 such as, for example, web sources 150-1 and 150-2. A single web source 150 such as, for example, web source 150-1, may be operated by a plurality of merchant devices 160, for example merchant device 160-1 and 160-2.

The e-commerce system 130 is configured to track the activity of a user of the consumer device 110. The activity may include, for example, an amount of time the user spent searching for a certain good or service, one or more gestures received from the user of the consumer device 110, queries, portions thereof, and so on.

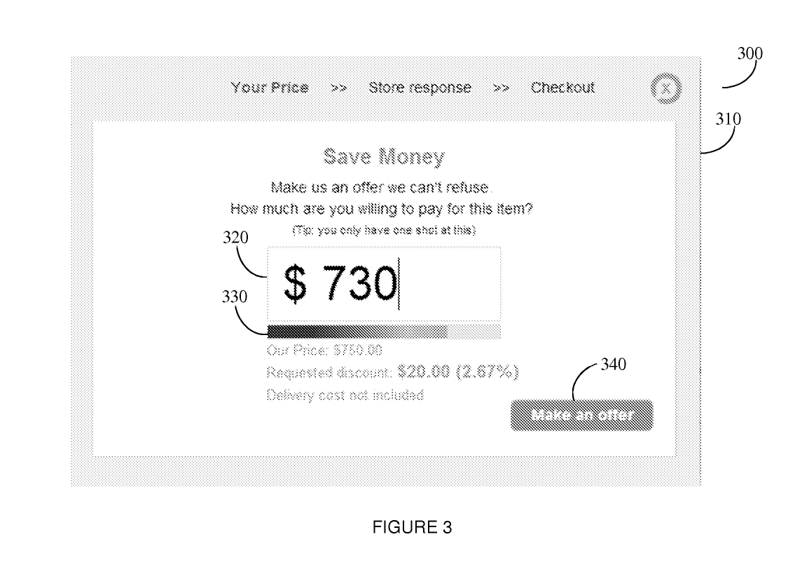

Upon identification that the user of the consumer device 110 is interested in a certain offer to purchase a product through the web source 150, the e-commerce system 130 is configured to allow the user to counter the offer, i.e., to set a price to the product of interest. With this aim, according to one embodiment, a widget or a link through which the user can counter the offer to purchase the product is generated and displayed over the user device. An exemplary implementation of a widget is further described herein below with respect to FIG. 3.

According to one embodiment, the e-commerce system 130 is configured to receive a counter offer from the consumer device 110. The number of counter offers that can be initiated and provided by the users may be limited to a predefined number. In an embodiment, the number of allowable counter offers is 1. In alternative embodiments, the counter offer may be a time-limited offer, i.e., an offer that must be approved by the client within a pre-configured period of time. The counter offer may be a binding offer, i.e., a consumer is obligated to complete the purchase transaction upon acceptance of the offer.

The e-commerce system 130 is configured to analyze the received counter offer and to collect or obtain metadata respective of the product on which an offer has been made. In an embodiment, the metadata is collected from a respective merchant device 160 offering the product for sale. In another embodiment, the metadata of a set of products (which may be popular) are saved in the e-commerce system 130. The metadata may be, but is not limited to, information regarding the minimum price at which the merchant is willing to sell the product, a minimum margin/price on a sale, an available quantity of the products, and so on.

It should be noted that metadata of a product is continuously updated, for example, by the merchant. As a result, a profitable transaction for the merchant may be guaranteed. According to another embodiment, the metadata may include one or more alternative offers responsive to the counter offer received from the consumer device 110. An alternative offer may be, for example, a discounted price to purchase the good or service, as well as a discounted price for add-ons or additional services related to the good or service.

According to various disclosed embodiments, the e-commerce system 130 is configured to generate a real-time estimation of whether the merchant will accept the counter offer. The estimation is made based on the metadata and other information extracted from the merchant device 160. Then, the e-commerce system 130 is configured to select content items to display on the display of the consumer device 110 respective of the counter offer and the collected metadata.

The content items are typically designed to motivate the user to purchase the product on which an offer has been made. The content item may be, for example, a recommendation related to the counter offer, a display segment showing an estimation that the merchant will accept the counter offer, current offers made by other users, available quantities of the product, and so on. The display segment may be, for example, a bar of a graph. The selected content items are then displayed on the display of the consumer device 110.

According to one embodiment, the e-commerce system 130 may further analyze the activity of the user of the consumer device 110 as well as other parameters related to the user and select the content items to display respective thereto. As a non-limiting example, the gathered user activity includes the number of times the user views the product of interest during a predefined time interval, the number of offers made on that product by the user, a number of pervious transactions made by the user, and so on. The user activity may be monitored across a plurality of web sources 150. The user's interest is determined based on the user activity, i.e., whether the user is a “serious buyer”. This is important information to the merchant, who may propose a greater incentive to a user who is known to be a serious buyer. The e-commerce system 130 may inform the merchant if the user is determined to be a serious buyer or the likelihood that user will complete a purchase transaction along with a recommendation related to the counter offer by the merchant and/or to an incentive that can be proposed to the user. Therefore, the disclosed embodiments allow tailoring incentives to specific users in order to motivate them to complete a transaction.

According to yet another embodiment, the selection of the content items to display is made by the merchant device 160. That is, the merchant device 160 provides a list of incentives, a number of available products, a merchant counter offer, and so on, to motivate the user to complete the transaction. A merchant may select any or all of the provided content items to display. In an embodiment, the merchant may also input a content item to be displayed. The selection of content items by the merchant device 160 is generally performed in response to recommendations and/or information collected and analyzed by the e-commerce system 130. In an embodiment, a database 170 is connected to the network 120 for storing information related to the users and merchants.

It should be noted that, while the system is described in a manner where the e-commerce system 130 is a separate device from the web source 150, such description should not limit the scope of the disclosed embodiments. In some implementations, the e-commerce system 130 or the functionality of the e-commerce system 130 may be integrated in a web source 150.

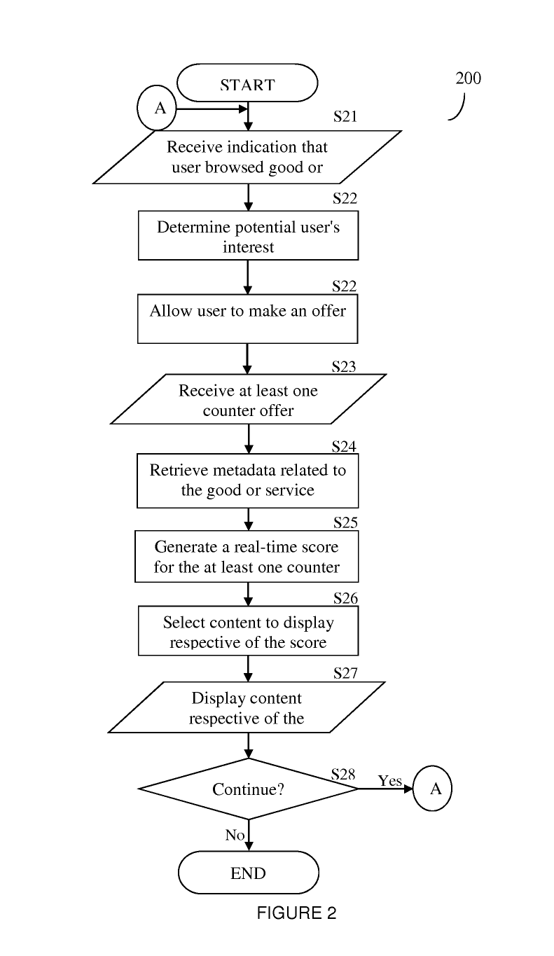

FIG. 2 depicts an exemplary and non-limiting flowchart 200 describing a method for effectuating an electronic negotiation between a consumer device and a merchant according to one embodiment. The electronic negotiation is personalized to a user of the user consumer device to motivate the user to complete a purchase transaction. In an embodiment, the method is performed by the e-commerce system 130.

In S210, an indication that a user of the consumer device browses products for sale on an e-commerce web-site (hosted by, e.g., one of web sources 150) is received. Such an indication may be provided by a script executed on the consumer device in response to accessing the e-commerce web-site. The indication may be derived from a cookie or similar data structure saved locally in the consumer device. It should be noted that access to the e-commerce website hosted on a web source can be facilitated by a browser, an application (app) installed on the user device, and the like.

In S220, a potential interest by the user to purchase at least one product offered by the e-commerce website is determined. The product may be any good and/or service offered for sale via the e-commerce website. The determination may be performed by tracking the user activity on the e-commerce web-site. In an embodiment, the determination may be implicit. As a non-limiting example of an implicit determination, upon identification that the user viewed, through the consumer device, a specification of the product, or that the user repetitively views a certain product or product category, it is determined that the user is interested in the product. The implicit determination may be derived from tracking the user activity across multiple websites.

The determination at S220 may also be based on an explicit indication. For example, the user adds the product to a shopping cart, but did not complete the transaction, thereby explicitly expressing interest in the product. As a result, an explicit determination that the user is interested in the product is made.

In S225, upon determination that there is a potential interest to purchase a product, a link or a widget allowing the user to make an offer to purchase the product is generated and displayed to the user. Such a link or widget can be display in a form of a pop-up window, a banner, embedded in a web-page viewed by the user, and so on. In an embodiment, the link or widget is displayed in real-time as it is determined that the user has an interest to buy the product. In another embodiment, the link or widget is displayed “off-line”, i.e., when the user ends a browsing web session with the e-commerce website.

In S230, at least one counter offer to purchase the product is received. According to one embodiment, the counter offer may be binding or time limited as described further herein above with respect to FIG. 1, subject to restrictions received from the merchant device offering the product to sale. In S240, metadata related to the product of interest is retrieved. The metadata may be retrieved from, for example, the merchant device 160 or the database 170.

In S250, a real-time score for the counter offer is computed. Such computation is typically performed respective of the retrieved metadata. The score may represent the likelihood that the merchant of the merchant device 160 will accept the counter offer. In an embodiment, the metadata may include, but is not limited to, a minimum price on a sale. In such an embodiment, if the counter offer is above the minimum price, a higher score is assigned to the counter offer. Similarly, if the counter offer is below the minimum price, a lower score will be assigned to the offer. The score may be computed based on a combination of parameters including, for example, a minimum price on a sale, a minimum margin on a sale, inventory, and so on. The computed score may be weighted over these parameters. In an embodiment, the counter offer and the computed score are sent to the merchant device.

As a non-limiting example of computing a weighted score, scores may range from 0 to 10, where 0 represents a low probability that the merchant will accept the counter offer and 10 represents a high probability that the merchant will accept the counter offer. In this example, the score is computed based on a minimum price that is set and the amount of inventory of the product that is available. Meeting the minimum price is assigned a weight of 0.8, and the amount of inventory is assigned a weight of 0.2. If the counter offer meets the minimum price and the amount of inventory for the product is very large, the counter offer may be assigned a score of (0.8*10)+(0.2*10)=10. In contrast, if the amount of inventory for the product is about average but the counter offer fails to meet the minimum price, the counter offer may be assigned a score of (0.8*0)+(0.2*5)=1.

In S260, at least one content item is selected to be displayed on the consumer device in response to the counter offer. The content items are designed to incentivize the user to make the purchase and/or to improve the offer made. The selection of the content is made based on the computed score and/or the analysis of user activity with respect to current and past transactions. The analysis of the user activity is described further hereinabove with respect to FIG. 1.

In S270, the at least one selected content item is displayed on the consumer device. It should be noted that multiple content items can be selected, where each selected content item may be displayed in response to the user decision of whether or not to improve the counter offer or to buy the product. For example, a first content item may display a discount of 5%, if the user does not respond to the first content item, a second content item offering both a 5% discount and free shipping is provided. In addition, a content item showing the inventory for the product or a time window to complete the transaction may be displayed as well.

In S280, it is checked whether execution will continue. If so, execution continues with S210; otherwise, execution terminates. The execution of the method may be terminated if, for example, the user purchased the product and/or there are not more content items to be displayed.

As a non-limiting example, an interest of the user in purchasing a laundry machine of a certain brand through the web source 150 is identified. The e-commerce system 130 extracts or obtains the minimum price that the merchant is willing to sell the laundry machine at. The e-commerce system 130 then receives a counter offer from the consumer device 110 to purchase the laundry machine at a price which is 10% below the minimum price. In response, the e-commerce system 130 is configured to generate a notification to the consumer device 110 stating that if the user will not offer a higher price, the counter offer will be rejected by the merchant device 160.

FIG. 3 depicts an exemplary and non-limiting screenshot 300 showing a real-time display of a widget 310 by an e-commerce server responsive to a counter offer received from a consumer device in accordance with an embodiment. The widget 310 contains an input area 320 through which the user of a consumer device (e.g., the consumer device 110) can insert a counter offer to purchase the good or service. The counter offer is analyzed in real-time and a score is generated respective thereto. An indicator 330, for example in the form of a bar having colors that move from red on one side to green on the other side, is then updated in real-time, thereby indicating the probability that a merchant device such as, for example, the merchant device 160 will accept the counter offer. This is provided responsive to the analysis.

The widget 310 may further contain a displayable button 340 through which the user of a consumer device can send the counter offer. According to an embodiment, a threshold is predetermined by a merchant device 160. In that embodiment, in case the counter offer received by the user of the consumer device does not cross the threshold, the displayable button 340 through which the user can counter the offer, is blocked. The threshold may be set to the minimum price for the product or based on a score for the counter offer computed as discussed above.

The various embodiments of the invention may be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for effectuating an electronic negotiation between a consumer device and a merchant, comprising:
receiving an indication that a user of the consumer device browses products for sale on an e-commerce website;
identifying an interest of the user respective of a product offered by the merchant on the e-commerce website;
requesting a counter offer to a price requested by the e-commerce website;
upon receiving the counter offer, retrieving metadata associated with the product;
computing a score representing a probability that a merchant of the product would accept the counter offer based on the retrieved metadata;
selecting at least one content item for display on the consumer device in response to the counter offer, wherein the at least one content item is selected based on the counter offer and the retrieved metadata, wherein the at least one selected content item is designed to incentivize the user to improve the counter offer; and
causing a display of the at least one selected content item on a display of the consumer device.

2. The method of claim 1, wherein identifying the interest of the user in the product is based at least one of: explicit identification and implicit identification.

3. The method of claim 1, wherein the metadata includes at least one of: a minimum price for the product, a minimum margin for the product, an inventory level of the product, and at least one alternative offer.

4. The method of claim 3, wherein the at least one alternative offer is modified respective of the counter offer.

5. The method of claim 1, wherein the at least one content item is at least one of: a recommendation related to the counter offer, and a display segment containing an estimation of a likelihood that the merchant would accept the counter offer.

6. The method of claim 1, wherein the at least one content item is selected via a merchant device of the merchant based on the computed score.

7. The method of claim 6, further comprising:
tracking user activity on the consumer device; and
selecting the at least one content item based on the user activity.

8. The method of claim 1, further comprising:
causing the display of each content item of the at least one selected content item sequentially, wherein the display of each content item is in response to the user feedback to a previously displayed content item.

9. A non-transitory computer readable medium having stored thereon instructions for causing a processing system to execute the method according to claim 1.

10. A system for effectuating an electronic negotiation between a consumer device and an merchant, comprising:
a processor; and,
a memory coupled to the processor, the memory containing instructions that, when executed by the processor, configure the system to:
receive an indication that a user of the consumer device browses products for sale on an e-commerce website;
identify an interest of the user respective of a product offered by the merchant on the e-commerce website;
request a counter offer to a price requested by the e-commerce website;
upon receiving the counter offer, retrieve metadata associated with the product;
compute a score representing a probability that a merchant of the product would accept the counter offer based on the retrieved metadata;
select at least one content item for display on the consumer device in response to the counter offer, wherein the at least one content item is selected based on the counter offer and the retrieved metadata, wherein the at least one selected content item is designed to incentivize the user to improve the counter offer; and
cause a display of the at least one selected content item on a display of the consumer device.

11. The system of claim 10, wherein the system is configured to identify an interest of the user in a particular product based at least one of: explicit identification and implicit identification.

12. The system of claim 10, wherein the metadata includes at least one of: a minimum price for the product, a minimum margin for the product, an inventory level of the product, and at least one alternative offer.

13. The system of claim 12, wherein the at least one alternative offer is modified respective of the counter offer.

14. The system of claim 10, wherein the at least one content item is at least one of: a recommendation related to the counter offer, and a display segment containing an estimation of a likelihood that the merchant would accept the counter offer.

15. The system of claim 10, wherein the at least one content item is selected via a merchant device of the merchant based on the computed score.

16. The system of claim 15, wherein the system is further configured to:
track user activity on the consumer device; and
select the at least one content item based on the user activity.

17. The system of claim 10, wherein the system is further configured to:
cause the display of each content item of the at least one selected content item sequentially, wherein the display of each content item is in response to the user feedback to a previously displayed content item.
